(19) United States
(12) Patent Application Publication
(10) Pub. No.: US 2013/0168890 A1
(43) Pub. Date: Jul. 4, 2013

(54) METHOD FOR CHARACTERIZING, MONITORING, AND CONTROLLING A MOLD, DIE, OR INJECTION BARREL

(71) Applicant: Kenneth E. Johnson, Hollis, NH (US)

(72) Inventor: Kenneth E. Johnson, Hollis, NH (US)

(73) Assignee: MOLDCOOL INTERNATIONAL LLC, Bow, NH (US)

(21) Appl. No.: 13/546,154

(22) Filed: Jul. 11, 2012

Related U.S. Application Data
(60) Provisional application No. 61/506,216, filed on Jul. 11, 2011.

(51) Int. Cl. B22D 17/32; B29C 45/78

(52) U.S. Cl. CPC B22D 17/32; B29C 45/78
USPC 264/40.1; 164/4.1

(57) ABSTRACT

In a method for thermally controlling a mold, initial measurements of flow versus pressure or pumping speed for a thermal exchange liquid are used to select an achievable flow within a maximum pressure. Subsequently, the system's identity and integrity are verified by repeating at least one measurement before and/or during a process run. An energy exchange rate can be adjusted to a moving average over preceding cycles. Thermal equilibrium can be detected by sensing changes in temperature to or from the process, or in energy exchange rates, from cycle to cycle. An energy exchange rate set point can be set to an initial value during startup, and then reset to an equilibrium value. Energy efficient operating conditions can be determined by comparing circulator energy consumption with thermal energy exchange rates over a range of flow rates and/or temperatures to the process. Cooling flow pulse timing can be graphically adjusted.

### RELATED APPLICATIONS

This application claims the benefit of U.S. Provisional Application No. 61/506,216, filed Jul. 11, 2011, which is herein incorporated by reference in its entirety for all purposes.

### FIELD OF THE INVENTION

The invention relates to methods for thermal control of a system, and more particularly to methods for thermally controlling a mold, die, or injection barrel.

### BACKGROUND OF THE INVENTION

Thermal exchange liquid circulator systems are commonly used in the plastics, metals, ceramics, and die cast molding industries to control the operating temperatures of molds, dies and injection barrels. These circulator systems typically include a mechanism for circulating a thermal exchange liquid through the mold, die, or injection barrel, as well as a mechanism for cooling the thermal exchange liquid, such as a built-in chiller, a heat exchanger in thermal communication with a central chilling system, or a water tower evaporative cooling system.

Similar thermal exchange liquid circulators are used in other industries for temperature control purposes. For example, a circulator is sometimes used for controlling the operating temperature in a two-component mixing process, such as molding liquid silicone rubber or LSR (sometimes called LIM), which is an exothermic process where heat is given off when the polymer chains cross link with each other. This type of process requires precise temperature control of a specially designed injection barrel, which keeps the two-part mixture from chemically setting up prematurely.

Note that except where the context specifically requires a mold, the term “mold” is used generically throughout this document to refer to a mold, die, injection barrel, extruder, or to any other apparatus which is thermally controlled by a thermal exchange liquid circulator.

Thermal exchange liquid circulators are referred to in various industries by different names. They are sometimes called temperature control units or “TCU's.” In some fields they are called “Thermolators.” They may also be called “water circulators.” In this document, unless the context requires otherwise, the term “circulator” is used generically for all types of thermal exchange liquid circulators.

Some thermal exchange liquid circulators use oil as the thermal exchange liquid medium, and are sometimes called “oil circulators” or “oil TCU's.” Oil circulators are primarily used to heat, not cool a mold, die or barrel. Water circulators can circulate water over a wide range of temperatures, depending on system pressure. By maintaining water at higher-than-ambient pressures, water-based circulator systems can be used for circulating water at temperatures up to 300° F., and in some cases as high as 500° F., and are commonly used where heating is desired instead of cooling, for example for the molding of thermoset plastics and other high-temperature plastics.

Circulators come in two basic types. One type of circulator is called “direct injection” and the other is called “closed loop.” The expressions “direct injection” and “closed loop” describe how the thermal exchange liquid that is directed from the liquid pump of the circulator to the process is returned to the main circulation system after it has exchanged energy with the molding process. Circulators can be configured to be both types, and can be convertible from one type to the other in the field. For convenience, the discussions presented in this paper are mainly directed to direct injection circulators, but it should be noted that the present invention is applicable to either type of circulator.

The amount of energy absorbed or shed by a thermal exchange liquid during circulation through a process depends on several variables, including details regarding the mold, details regarding the thermal exchange liquid, details regarding the process taking place within the mold, and details regarding the thermal exchange liquid circulator. With regard to the mold, for example, variables may include the thermal conductivity of the material of which the mold is fabricated, the volume of the mold, the mass of the mold, the amount and temperature of the material being molded, the amount of surface area of the mold which is exposed to localized and/or total ambient air temperatures, and other incidental or purposeful environmental heating and cooling influences which affect the mold.

With regard to the process, variables can include the location and concentration of the plastic or other moldable material within the mold, the range of variation or curve of thermal demand or excess over a cycle of operation, the duration of the thermal mold cycle, and the dwell time between cycles.

With respect to the thermal exchange liquid, relevant variables can include the viscosity, the thermal conductivity, the density, and the heat capacity.

With regard to the circulator, relevant variables can include the proximity of the process within the mold to the network of thermal exchange liquid channels in the mold, the absolute temperature of the thermal exchange liquid, the average temperature differential between the thermal exchange liquid and the process, the absolute and average rates of BTU transfer between the thermal exchange liquid and the process which are required to sustain a repetitive or continuous process, the volume and surface area of the thermal exchange liquid channels within the mold, and the time of exposure and flow rate of the thermal exchange liquid within the mold. The thermal exchange liquid circulator must have the capacity to supply and control a sufficient quantity of thermal exchange liquid at the right temperature and rate to satisfy the requirements of the molding process.

Using an example of a water circulator being used to control the temperature of a plastics injection mold, the direct injection of molten plastic into the mold adds heat to the mold, which must be extracted by the thermal exchange liquid. The circulator therefore injects cooled water into the mold and extracts heated water from the mold. In a closed-loop system, a “loop of water” is circulated between the pump and the mold. In some of these systems, the circulator removes heated water from the loop and adds cooled water to the loop as needed so as to control the temperature of the loop of water, and thus the temperature of the process. In other systems, the liquid circulation path includes a water-to-water heat exchanger, which removes the excess heat picked up by the loop of water from the molding process. In some of these systems, coolant supplied to the heat exchanger is adjusted or cycled on and off so as to control the temperature of the closed loop of thermal control liquid.

Typically, the circulator includes a pump of some sort which controls the flow of thermal exchange liquid through the mold. The pump can be a rotary pump that operates an impeller at a fixed or variable speed, depending on the control system, but provides an output that depends strongly on back pressure. Or it may be a fixed displacement pump, such as a piston-driven pump or a gear pump, that outputs a substantially fixed volume of liquid for each cycle.

The pump may be configured to run at a constant speed, or it may have a variable speed which can be controlled according to requirements of the molding process and/or in response to measured temperature fluctuations. As an alternative or in addition to a variable speed pump, a controllable valve can be used to control the rate of flow of thermal exchange liquid through the mold. Some systems use a pulsed flow system, wherein thermal control liquid is supplied to the process in pulses or bursts by opening and closing valves and the degree of cooling (or heating) of the mold is controlled by the average on/off ratio of the valves.

Molding systems vary considerably as to the supply pressure that is available, the back pressure that is generated (e.g. if many circulator pumps are installed on a plurality of molding systems), and the maximum pressure that they can tolerate. Therefore, even if satisfactory operating conditions are known in theory or are known from practical experience from a first molding system, it is quite possible that a desired flow rate will not be available for a second molding system due to the constraints that are applicable to that system.

The quality and consistency of the product produced by a mold, die, or injection barrel production run depends strongly on the repeatability and consistency with which the process is thermally controlled. When a new molding run is to be initiated, typically the mold is mounted in a press and the system is operated under various conditions until a satisfactory set of operating conditions is established. This procedure can be time consuming and wasteful of product, but can nevertheless be critical to a successful run, especially if the process is highly sensitive to the operating conditions.

In addition, even when a satisfactory set of operating conditions has been identified, it may be desirable to continue trying other sets of conditions in an attempt to reduce the energy cost of operating the circulator, which can be significant. The circulator energy cost includes the cost of operating the thermal exchange liquid circulation pump, as well as costs for cooling the thermal exchange liquid after it has flowed through the mold and/or for chilling additional liquid to be added to the returning thermal exchange liquid, so as to bring the thermal exchange liquid back to its set point temperature. In the case of a process which must be heated rather than cooled, the energy cost for heating the thermal exchange liquid can be significant.

Unfortunately, the additional time and expense of searching for acceptable operating conditions which also minimize circulator energy consumption can be prohibitive. Therefore, it is often a necessary compromise to operate the circulator under conditions which are satisfactory in terms of producing an acceptable product, but which nevertheless waste circulator energy and increase cost.

Very often when a previously successful molding run is to be repeated, much of the time and cost of setting up the run can be avoided if the press and circulator which were previously used can be re-used, and can be configured to repeat the operating conditions and molding cycle which were previously established as giving acceptable results. In these cases, it can be important to be certain that the same press and circulator which were previously used have been correctly identified and selected, or that sufficiently identical components have been selected. If the press and/or circulator which were previously used are not available, the previously established operating parameters may be unusable without adjustment, and it may be difficult, time consuming, and costly to re-establish a successful set of operating parameters. And if the wrong press and/or circulator is mistakenly selected, a considerable loss of time and product may result before the error is detected, after which a new set of operating parameters may need to be established.

Even if the identical apparatus is available and is correctly identified, the system may have changed or degraded in some way since it was previously used for the same process. For example, the plumbing of the liquid circulation system may have changed due to maintenance, repair, or for some other reason, or some portion of the system may have degraded or failed, for instance due to a clogged circulation line or a degraded or faulty valve. This may cause the previously established operating parameters to produce unsatisfactory results, until the problem is discovered and either the system is returned to its previous condition or the operating parameters are adjusted to compensate for the changes.

Once appropriate operating parameters have been established and a production run has been initiated, it is usually necessary to wait until the system has reached thermal equilibrium before the produced parts can be retained and used with confidence. Typically, product from a certain number of initial “warm-up” molding cycles is discarded, so as to (hopefully) allow the system to reach thermal equilibrium. Often, the number of warm-up cycles is selected according to some sort of “rule of thumb,” which is typically greater than what is actually needed, since it is important to err on the side of discarding all potentially defective product, even if some usable product is also discarded.

It is sometimes desirable to operate a molding process at a high rate of speed, so as to produce product as rapidly as possible. This necessarily requires that heat be removed from (or added to) the mold at a high rate. The equilibrium temperature of the mold will depend on a balance between the rate at which raw material is added to the mold, and the rate at which heat is exchanged between the thermal exchange liquid and the mold. However, it is usual to begin circulation of the thermal exchange liquid through the mold well before a molding run is started. This means that when the molding run is first started, the mold will typically be at a temperature which is approximately equal to the temperature of the thermal exchange liquid, which may be too cold (or too warm) for the molding process. In extreme cases, the plastic or other raw material may harden too quickly and fail to completely fill the mold, or it may fail to harden by the end of the molding cycle. In either case, the molded material may fail to eject properly, and may cause a failure of the process to start.

Also, if it becomes necessary to temporarily stop a molding run, for example to remove a part which did not eject properly or to make a minor repair, the mold may drift into an untested thermal state somewhere between the tested startup conditions and the tested running conditions. Restarting of the molding run may subsequently fail, if the untested thermal state is not compatible with the start-up procedure.

Even after the production run is successfully underway, conditions in the system may nevertheless change, thereby causing the product to degrade and be unusable. For example, the ambient temperature may change, physical or chemical properties of the raw material may vary from batch to batch, or equipment may become clogged or otherwise may degrade in performance. This can lead to additional delay and cost before the problem is discovered and corrected.

In an attempt to monitor the actual conditions in the mold and to thereby detect and/or compensate for changes in the apparatus, raw materials, or environment, one or more temperature sensors are sometimes placed in the mold, and the rate of cooling is adjusted according to the measured temperatures, thereby hopefully establishing and maintaining stable and repeatable mold conditions. However, temperature sensors in the mold are necessarily remote from the substance being molded, and can only measure local temperatures within the mold itself, which typically has a very high thermal mass. This prevents the sensors from providing accurate indications of the actual temperature of the molded material. Also, there is typically a considerable time lag before a change in temperature of the molded material is indirectly detected by the temperature sensors. This can cause compensating actions of the circulator to be significantly delayed, and can lead to overreactions of the circulator whereby the stability of the system is made worse by the attempts to regulate the mold temperature.

What is needed, therefore, are techniques for determining the operating characteristics of a mold and circulator so as verify their identity and integrity, optimizing circulator energy efficiency, accurately repeating previously established operational conditions, accurately determining when the system has reached start-up equilibrium, reliably starting a molding run and bringing it successfully to equilibrium, monitoring the status of the molding apparatus during a molding run so as to detect equipment degradation and/or failures, and precisely monitoring and controlling the thermal conditions to which the molded material is subjected during each molding cycle, thereby providing repeatable results even when a system's configuration or status has changed, or the process has been moved to a different press and/or circulator.

### SUMMARY OF THE INVENTION

Various aspects of the present invention monitor the pumping speed, pressure, flow rate, temperature to the process, and temperature from the process of the thermal exchange liquid supplied to a mold, die, or injection barrel, as well as the circulator energy consumption, so as to characterize the operating limits of the apparatus and assist in selecting achievable operating conditions, verify the identity and integrity of the apparatus, optimize energy efficiency, accurately determine when start-up equilibrium has been achieved, detect any changes which may occur during a production run, and reproduce and control the thermal environment to which the plastic or other molded substance is subjected, thereby providing consistent, expected results even when the configuration or status of the apparatus has changed, or a different apparatus is being used.

In one general aspect of the present invention, for a specific configuration of molding apparatus, the user is allowed to enter a desired flow rate as well as a maximum pressure, and in some embodiments also an “alarm pressure” at which an alarm should be issued notifying the operator that the system is approaching its maximum pressure. The pumping speed versus flow rate, the pressure to the process versus flow rate and/or the differential process pressure (pressure to the process minus pressure returning from the process) versus the flow rate of the thermal exchange liquid are then measured over a range of conditions, which in some embodiments is the range from 98% of the specified maximum pressure and/or a set limit differential pressure down to 10% of the set limit pressure. Pumping speed versus flow and/or pressure versus flow data is established, sometimes in the form of a pumping speed versus flow curve and/or a pressure versus flow curve. The measured data is then used to determine if the desired flow rate is achievable without exceeding the maximum pressure. If not, then the user is informed of the maximum available flow rate and is invited to adjust the operating conditions accordingly.

In embodiments, the control system also includes a specified maximum pressure, and will not accept user specified pressures that exceed that limit.

In addition, the measured pumping speed versus flow and/or pressure versus flow data is used as a “fingerprint” for identifying the specific apparatus and configuration. During a subsequent molding run, a measurement of at least one pumping speed versus flow rate or pressure versus flow rate value, typically from a middle portion of the measured curve, is repeated and compared to the value or values obtained during the original molding run to ensure that the same or identical equipment is being used, and that the thermal exchange liquid circulation system has not changed or degraded since the process was previously run. In embodiments, the entire pumping speed versus flow and/or pressure versus flow data curve measurements are repeated and compared.

In embodiments, once the initial pumping speed versus flow and/or pressure versus flow data have been measured, at least one value of pumping speed versus flow or pressure versus flow is monitored or periodically checked during a molding run to detect any changes in the circulation system during the production run. In some embodiments, pumping speed versus flow and/or pressure versus flow measurements are repeated periodically during the molding run at a few different pumping speeds or pressures, so as to better detect any changes in the system. If a change in the system is detected beyond specified limits, the operator is alerted to re-optimize the operating conditions and measure a new set of pumping speed versus flow and/or pressure versus flow data.

In embodiments, measurements of flow versus both pressure and pumping speed are made before beginning the process run and during the process run, so that variations in pumping speed versus pressure can be used to detect and/or anticipate an eventual requirement to refurbish or replace the circulator.

Measured changes in pumping speed versus flow over time are also used in some embodiments to monitor pump degradation, and to anticipate an approaching requirement to service or replace a pump.

In another general aspect of the present invention, the rate of energy exchange between the thermal exchange liquid and the mold is determined. In embodiments, this includes measurement of the temperatures of the thermal exchange liquid to and from the process. In various embodiments, the energy exchange is measured on a cycle-by-cycle basis. In some embodiments, the rate of energy exchange between the thermal exchange liquid and the mold is monitored during start-up of a production run, and the system is deemed to have reached start-up equilibrium once the rate of energy exchange is constant from cycle to cycle within specified criteria.

In various of these embodiments, the flow rate and the temperature of the liquid delivered to the process are held substantially constant (in some of these embodiments, the temperature to the process is held to within 0.1 degrees Fahrenheit), and changes in the temperature of the liquid returned from the process are monitored. In other embodiments, the temperature and/or flow rate of the liquid delivered to the process follows a repeated pattern during each molding cycle, and the temperature of the liquid returning from the process is sampled at a specific point in each mold cycle, such that the system is deemed to have reached equilibrium when the sampled points vary by no more than a specified amount from cycle to cycle.

In still another general aspect of the present invention, the rate of energy exchange between the thermal exchange liquid and the mold is monitored and controlled as the process is started. During one or more start-up molding cycles (or other start-up time periods) the energy exchange rate set point is set to relatively lower values than the energy set point after the process reaches equilibrium and the actual molding run has begun. This allows the molding run to start properly and then to progress to the desired equilibrium state. In some embodiments, the set point for the temperature of the thermal exchange liquid supplied to the process is also set to a higher or lower value than the temperature set point after the process reaches equilibrium. In some embodiments, instead of discrete start-up time intervals and set points the energy set point (and in some embodiments also the set point temperature supplied to the process) transitions from a starting value to the equilibrium value according to a startup profile.

In various embodiments, the process is brought to equilibrium with a first energy exchange rate set point before operation of the process is started, so as to ensure that the system has reached a known and tested state. The remainder of the startup procedure is then followed under known and tested conditions. In certain embodiments, this approach applies also to situations wherein a molding run is temporarily halted, for example to remove a part which has failed to properly eject, or to make a minor repair. When the process is ready for re-start, it is initially brought from whatever untested state it has reached back to equilibrium with the first energy exchange rate set point. The remainder of the startup procedure can then be followed under known and tested conditions.

In certain embodiments where the equilibrium molding temperature is lower than the start-up temperature, a heater is included in the thermal exchange liquid system, and is used to temporarily warm the thermal exchange liquid to assist in quickly bringing the mold to its calibrated starting temperature, either when a new run is started, or if a molding run is temporarily halted for some reason. In some of these embodiments the heater is a tankless water heater, and the flow rate of the thermal exchange liquid is temporarily reduced during this warm-up process so that the liquid can be heated by the heater to a specified temperature.

In yet another general aspect of the present invention, the flow rate and the temperatures of the thermal control liquid to and from the process are monitored during a molding run, and a rate of energy exchange with the mold is calculated. A desired rate of energy exchange between the thermal exchange liquid and the mold is established as an energy set point, and if the characteristics of the mold, press, or circulator change, or if a different press or circulator is used, the system is adjusted so as to maintain the energy set point during each cycle. In some embodiments, the rate of energy exchange is not constant, but varies according to a desired energy set point profile during each mold cycle. In these embodiments, the system is controlled so as to maintain the desired energy exchange profile during each cycle, even if the characteristics of the apparatus change or a different press or circulator is used.

In some of these embodiments the energy set point is established by operating the molding system under a selected set of initial conditions and measuring an average rate of energy exchange over a plurality of molding cycles or an otherwise specified time period. In some of these embodiments, the average is over 30 minutes or over 30 molding cycles. The averaging continues during the molding run, and the energy set point is continually adjusted according to the “rolling average” energy exchange rate. In some of these embodiments, an error response is initiated if the energy set point migrates beyond specified limits. In some of these embodiments, the error response is stopping the process, sending an error message to an operator, and/or initiating a perceptible alarm signal.

In still another general aspect of the present invention, during the establishment of operating conditions for a molding run, the energy consumption of the circulator and the rate of energy exchange between the thermal exchange liquid and the mold are monitored under a variety of different flow rates and/or other sets of operating conditions. An energy consumption versus energy exchange relationship is established and used to determine the operating conditions under which thermal energy exchange with the mold has the lowest circulator electrical energy cost. In some embodiments, only the circulator pump energy consumption is monitored, while in other embodiments the total energy consumption of the circulator is monitored, including energy required to cool or heat the thermal exchange liquid.

The present invention is a method for establishing initial operating conditions for a molding system, the molding system including an injection mold, die, or barrel (herein referred to as a “process”), a circulator, and a thermal exchange liquid circulated by the circulator through the process. The method includes, before beginning a first process run, accepting from a user a desired flow rate of the thermal exchange liquid and a maximum value of an operating pressure of the thermal exchange liquid, measuring and recording a flow rate value of the thermal exchange liquid for each of a plurality of values of a flow control parameter spanning a range of achievable values of the flow control parameter, said range of achievable values being limited so that no value within said range causes the operating pressure to exceed the maximum value of the operating pressure, determining from the measured flow rate values if the desired flow rate can be provided by setting the flow control parameter to a value within the range of achievable values. if the desired flow rate can be provided, setting an operating value of the flow control parameter to a value that provides the desired flow rate, if the desired flow rate cannot be provided, informing the user and taking at least one further specified action, and beginning the process run.

In embodiments, the flow control parameter is an operating speed of the circulator. In some embodiments, the flow control parameter is a pressure of the thermal control liquid as it enters the process. In other embodiments, the flow control parameter is a pressure of the thermal control liquid as it exits the process.

In various embodiments the flow control parameter is a difference between pressures of the thermal control liquid as it enters the process and exits the process. In certain embodiments the plurality of values of the flow control parameter includes a value that is 98% of a maximum achievable value, a value that is 90% of the maximum achievable value, and values successively reduced from said 90% value in 10% increments.

Embodiments further include accepting from said user an alarm value of the operating pressure proximal to said maximum value, said alarm value being a value at which, when achieved, an alarm should be issued to said operator alerting said operator that the operating pressure is close to the maximum value. In some of these embodiments at least one further specified action includes setting the operating pressure to the alarm pressure, and informing the user as to the resulting flow rate.

In some embodiments, the at least one further specified action includes setting the operating value of the flow control parameter to the value within the range of achievable values that provides a flow rate that is as close as possible to the desired flow rate, and informing the user as to the resulting flow rate.

In other embodiments the at least one further specified action includes informing the user of the range of flow rates that can be achieved and the corresponding values of the flow control parameter from the range of achievable values of the flow control parameter, allowing the user to revise the desired flow rate to an achievable value, and setting the operating value of the flow control parameter to a value that provides the revised desired flow rate.

In various embodiments the maximum pressure accepted from the user is not allowed to be more than a specified system maximum pressure value.

Certain embodiments further include, after beginning the first process run, measuring a verification flow rate value of the thermal exchange liquid for at least one of the plurality of values of the flow control parameter, and verifying that the verification value is within a specified tolerance of the previously measured value. Some of these embodiments further include, if the verification fails, stopping the first process run and alerting an operator of the process. In other of these embodiments measuring the verification flow rate value includes temporarily pausing the first process run while the flow rate value is measured. In still other of these embodiments measurements of flow versus both pressure and pumping speed are made before beginning the first process run and are compared with verification measurements made during the first process run, and variations in pumping speed versus pressure are used to at least one of detect and anticipate an eventual requirement to refurbish or replace the circulator.

Various embodiments further include, after completing the first process run and before beginning a second process run, measuring a verification flow rate value of the thermal exchange liquid for at least one of the plurality of values of the flow control parameter, and verifying that the verification value is within a specified tolerance of the corresponding value measured before beginning the first process run. Some of these embodiments further include, if the verification fails, at least one of inspecting, repairing, replacing, cleaning, and adjusting at least one element of the molding system. Other of these embodiments further include, if the verification fails, measuring and recording a new flow rate value of the thermal exchange liquid for each of the plurality of values of the flow control parameter spanning the range of achievable values of the flow control parameter, and establishing new initial operating conditions for the molding system.

In still other of these embodiments a verification flow rate value is measured for each value of the thermal exchange liquid for which a flow rate value was measured before beginning the first process run, and the verification fails if any of the verification flow rate values is not within the specified tolerance of the corresponding value measured before beginning the first process run. And in yet other of these embodiments measurements of flow versus both pressure and pumping speed are made before beginning the first process run and are compared with verification measurements before beginning the second process run, and variations in pumping speed versus pressure are used to at least one of detect and anticipate an eventual requirement to refurbish or replace the circulator.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a functional diagram of a typical thermal exchange liquid circulator of the prior art;

FIG. 2 is a functional diagram illustrating a thermal exchange liquid circulator according to an embodiment of the present invention, including apparatus for monitoring of the pressure, flow rate, and temperature of the thermal exchange liquid delivered to a mold, the pumping speed, the electrical energy used by the pump, and the temperature and pressure of the thermal exchange liquid returning from the process;

FIG. 3A is a flow diagram illustrating steps in obtaining pumping speed versus flow rate data in an embodiment of the invention.

FIG. 3B is a flow diagram illustrating steps in obtaining pressure versus flow rate data in an embodiment of the invention.

FIG. 3C is a pumping speed versus flow rate curve generated using the steps of FIG. 3A according to an embodiment of the present invention;

FIG. 3D is a pressure versus flow rate curve generated using the steps of FIG. 3B according to an embodiment of the present invention;

FIG. 4A is a flow diagram illustrating a method of specifying a process flow rate according to an embodiment of the present invention;

FIG. 4B is a flow diagram illustrating steps used in certain embodiments for verifying the identity and integrity of a mold system by comparing measurements made before a first process run with measurements made before a second process run;

FIG. 4C is a flow diagram illustrating a process used in certain embodiments for monitoring the integrity of a process during a run, or verifying the continued integrity of a process after a temporary stopping of a process run.

FIG. 5A presents a typical set of temperature and flow rate measurement curves measured during a mold cycle by the apparatus of FIG. 2 where the flow rate is controlled according to a shaped flow profile;

FIG. 5B presents a typical set of temperature and flow rate measurement curves measured during a mold cycle by the apparatus of FIG. 2, where the flow is applied in a burst mode having a fixed flow amplitude beginning at a user-specified time during each cycle and continuing for a user-specified duration, there being substantially no flow except during the bursts;

FIG. 6 presents a typical curve showing the approach to start-up equilibrium of a selected point from the temperature curve of FIG. 5A in successive mold cycles;

FIG. 7A illustrates a visible indication presented by the circulator in an embodiment of the present invention indicating that the temperature of thermal exchange liquid returned from the process is below the equilibrium value;

FIG. 7B illustrates a visible indication presented by the circulator in the embodiment of FIG. 7A indicating that the temperature of thermal exchange liquid returned from the process is above the equilibrium value;

FIG. 7C illustrates a visible indication presented by the circulator in the embodiment of FIG. 7A indicating that the temperature of thermal exchange liquid returned from the process is within a specified maximum offset from the equilibrium value;

FIG. 7D illustrates a simple visible indication presented by the circulator in an embodiment indicating that the temperature of thermal exchange liquid returned from the process is within a specified maximum offset from the equilibrium value, the indication begin given without any reference to a direction of approach to equilibrium;

FIG. 8A is a typical energy exchange curve calculated over a mold cycle according to an embodiment of the present invention;

FIG. 8B is a graph which illustrates startup time intervals and energy exchange rate set points during a startup phase of a molding run according to an embodiment of the present invention; and

FIG. 9 is a flow diagram illustrating a method of regulating energy exchange between a thermal exchange liquid and a process according to an embodiment of the present invention.

### DETAILED DESCRIPTION

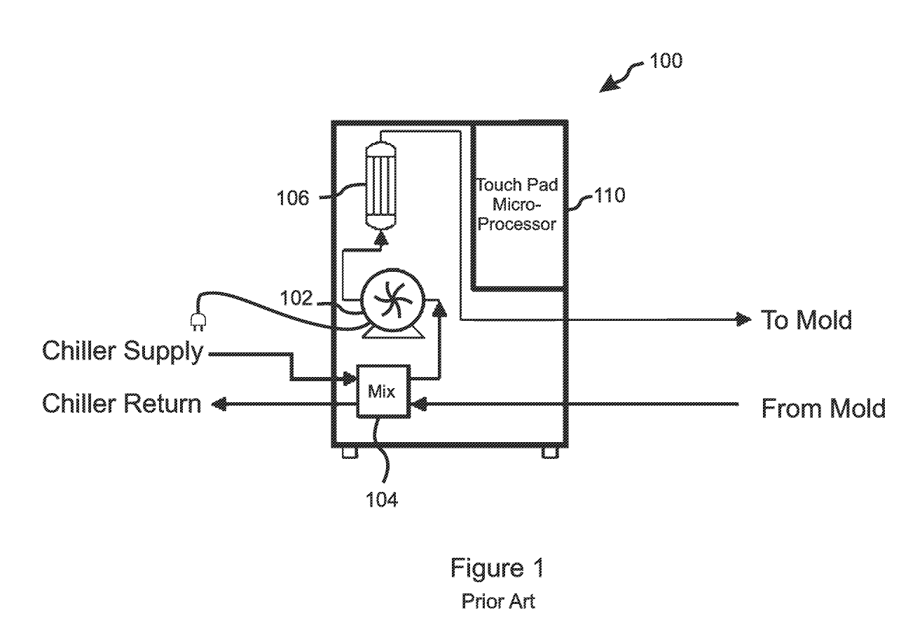

With reference to FIG. 1, a thermal exchange liquid circulator system 100 is commonly used in the plastics, metals, ceramics, and die cast molding industries to control the operating temperatures of a mold, die, or injection barrel (generically referred to herein as the “mold” or the “process”). These circulator systems 100 typically include a rotary pump 102 or other mechanism for circulating a thermal exchange liquid through the mold, die, or injection barrel, as well as a mechanism 104 for cooling the thermal exchange liquid, such as a chilled water direct injection system 104, a built-in chiller, a heat exchanger in thermal communication with a central chilling system, or a water tower evaporative cooling system. In the example illustrated in FIG. 1, the circulator further includes a heater 106, and a touch pad microprocessor control system 110.

Circulators 100 such as the example illustrated in FIG. 1 provide varying degrees of control over the temperature and flow rate of the thermal exchange liquid to the process. In an attempt to monitor the actual conditions in the mold and to thereby detect and/or compensate for changes in the apparatus, raw materials, or environment, one or more temperature sensors (not shown) are sometimes placed in the mold and monitored either by a human operator who controls the circulator 100, or by the automatic control system 110 of the circulator 100, which adjusts the rate of cooling (typically the temperature set point to the process) according to the temperatures measured in the mold in an attempt to establish and maintain a stable and repeatable mold temperature.

However, temperature sensors in the mold are necessarily separated from the substance being molded, and can only measure local temperatures within the mold itself, which typically has a very high thermal mass. This prevents the sensors from providing accurate indications of the actual temperature of the molded material. Also, there is typically a considerable time lag before a change in temperature of the molded material is indirectly detected by the temperature sensors. This can cause compensating actions of the circulator 100 to be significantly delayed, and can lead to overreactions of the circulator 100 whereby the stability of the system is made worse by the attempts to regulate the mold temperature. In addition, the temperatures sensors can record temperatures only at one or at a few discrete locations, and may not give an adequate measurement of the overall temperature status of the process.

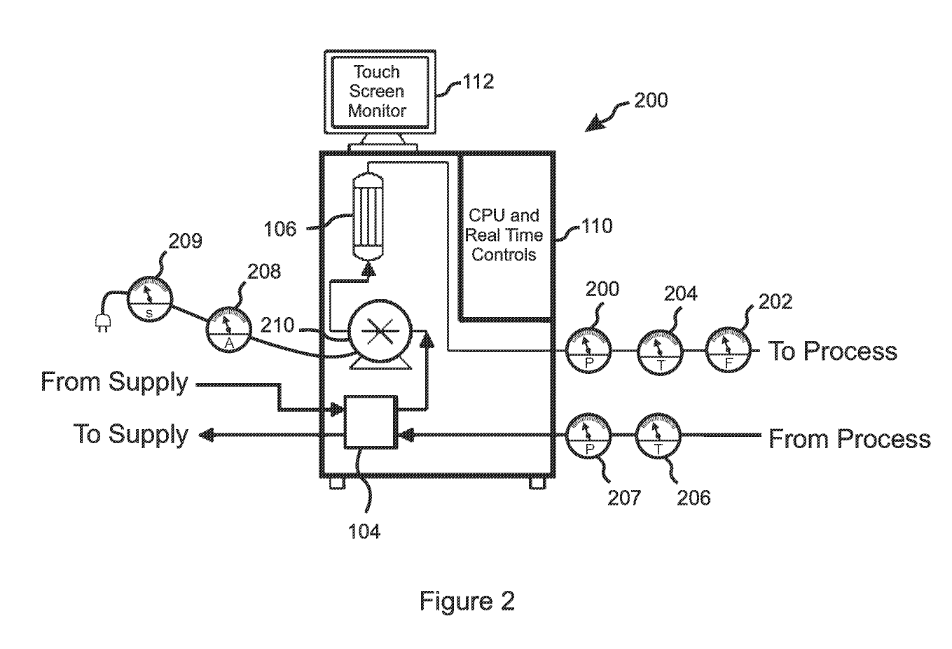

With reference to FIG. 2, in various embodiments the present invention includes apparatus to measure the pressure 200, flow rate 202 and/or temperature 204 of the thermal exchange liquid supplied to the process, and/or the temperature 206 and pressure 207 of the thermal exchange liquid as it emerges from the process and returns to the circulator 200. Embodiments also include measurement of the energy consumed by the circulator, including the energy 208 consumed by the pump 102 and in some embodiments also by the chiller (not shown). Some embodiments include measurement of the pumping speed 209. In the embodiment of FIG. 2, a fixed displacement pump 210 is used to drive the thermal exchange liquid.

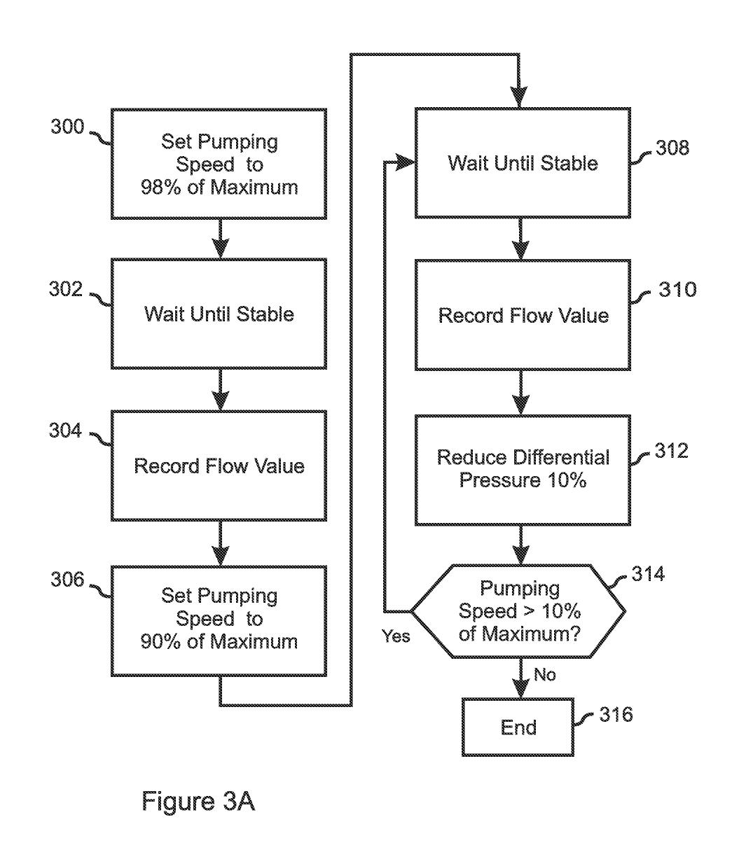

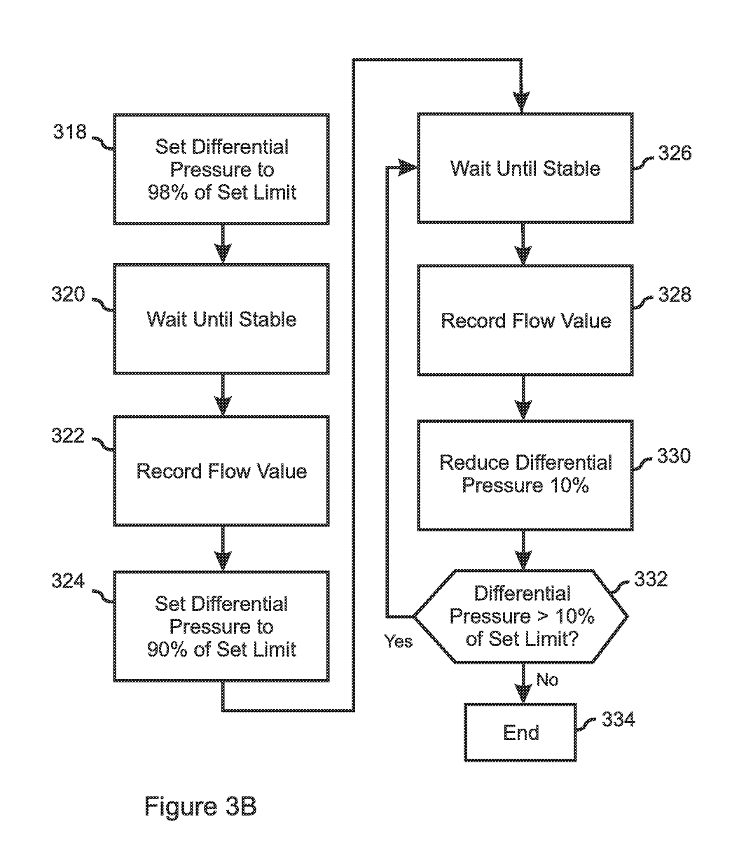

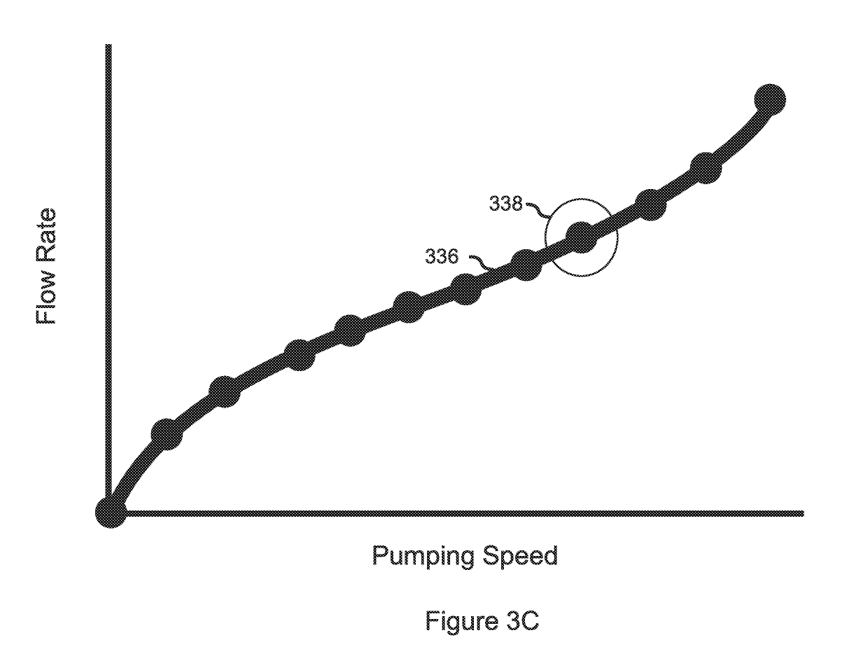

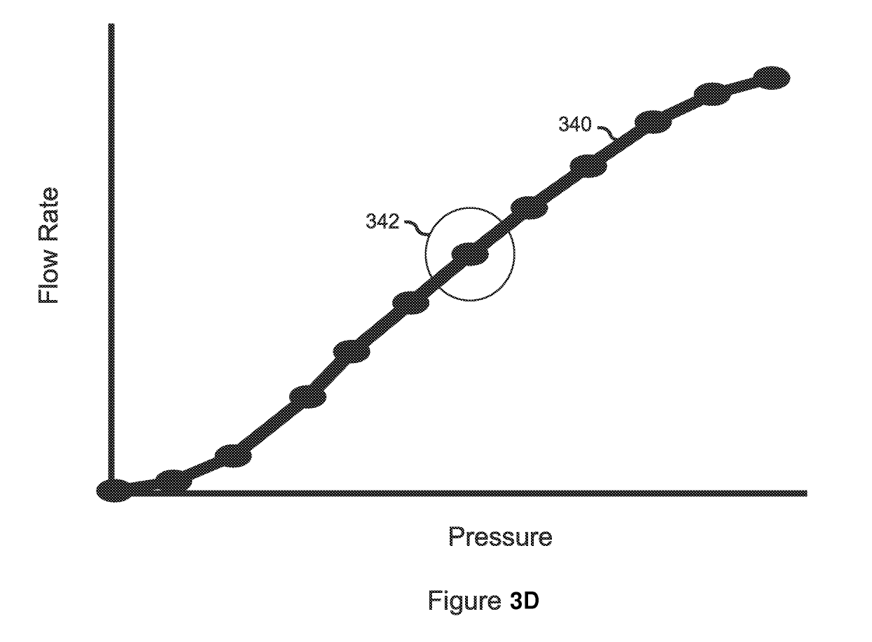

With reference to FIG. 3A, in embodiments after assembling and preparing the system, a series of measurements of flow 202 versus pumping speed 209 are made over a wide range of pumping speeds. The pumping speed 209 is initially set to a high value, which in the embodiment of FIG. 3A is 98% of the maximum pumping speed 300. The system is allowed to stabilize 302, and then the flow 202 value is recorded 304. The pumping speed 209 is then reduced to 90% of the maximum 306, the system is again allowed to stabilize 308, and another measurement of the flow rate 202 is recorded 310. The pumping speed 209 is then reduced by 10% 312, and the process is continued in increments of 10% until the pumping speed 209 is below 10% of the maximum 314, at which point the measurements are terminated 316.

With reference to FIG. 3B, in similar embodiments after assembling and preparing the system, a series of measurements of flow 202 versus pressure 200 are made over a wide range of pressures. The pressure 200 is initially set to a high value, which in the embodiment of FIG. 3A is 98% of the maximum pressure 318. The system is allowed to stabilize 320, and then the flow value is recorded 322. The pressure 200 is then reduced to 90% of the maximum 324, the system is again allowed to stabilize 326, and another measurement of the flow 202 rate is recorded 328. The pressure 200 is then reduced by 10% 330, and the process is continued in increments of 10% until the pressure 200 is below 10% of the maximum 332, at which point the measurements are terminated 334.

With reference to FIGS. 3C and 3D, the measurement results are used to create a pumping speed versus flow curve 336 and/or a pressure versus flow curve 340 for the system. Note that unless the context specifically requires otherwise, the term “pressure” is used herein to refer to any of the pressure supplied to the process, the pressure returning from the process, and the differential pressure defined as the difference between the pressure supplied to the process and the pressure returning from the process.

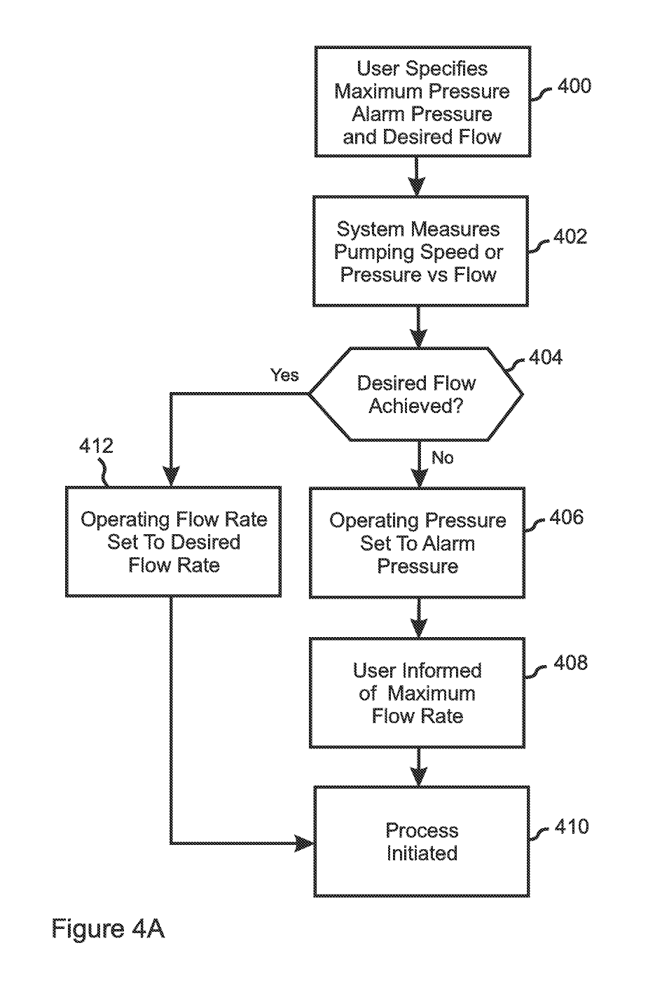

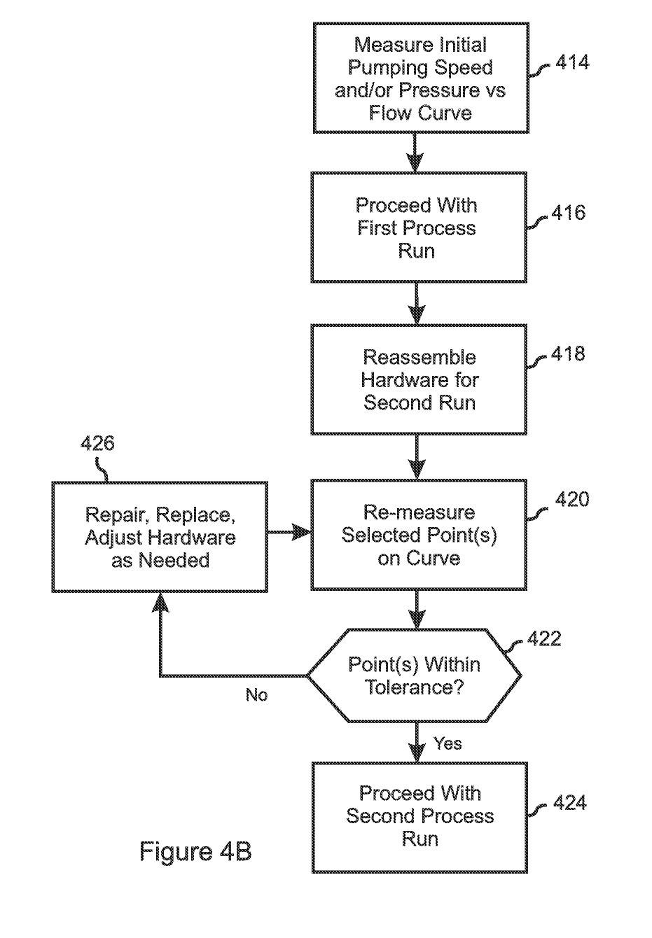

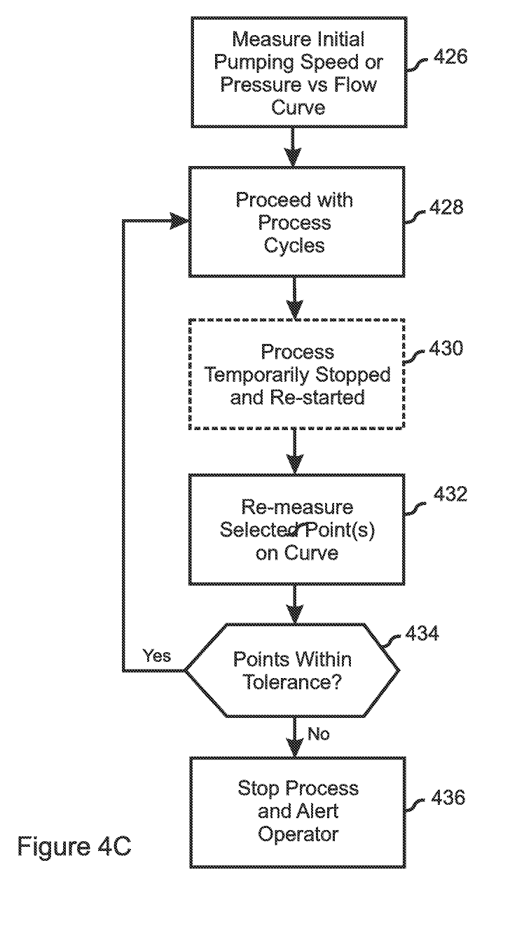

With reference to FIG. 4A, in one general aspect of the present invention, for a specific configuration of a process apparatus, the user is allowed to enter a desired flow rate as well as a maximum pressure, and in some embodiments also an “alarm pressure” at which an alarm should be issued notifying the operator that the system is approaching its maximum pressure 400. The pumping speed 209 versus flow rate 202 and/or the pressure to the process 200, pressure from the process 207 or the difference between the two pressures (the differential pressure) versus the flow rate 202 of the thermal exchange liquid are measured 402 over a range of conditions, as illustrated in FIGS. 3A and 3B.

The measured data 336, 340 are then used to determine if the desired flow rate is achievable 404 without exceeding the maximum pressure or a maximum pumping speed. If not, then in the embodiment of FIG. 4A the operating flow is set to the flow achieved at the alarm pressure 406 (which provides a flow rate as close to the desired flow rate as possible without exceeding the maximum pressure). The user is then informed of the maximum available flow rate and is invited to adjust the operating conditions accordingly 408. Finally, the process is initiated 410. If the desired flow rate is achieved at a pressure below the alarm pressure, then the operating flow rate is set to the desired flow rate 412 and the process is initiated 410.

In embodiments, the control system also includes a factory-specified maximum pressure, and will not accept user specified pressures that exceed that limit.

With reference to FIG. 4B, in some embodiments the measured pumping speed versus flow 336 and/or pressure versus flow 340 data is used as a “fingerprint” for identifying the specific apparatus and configuration and verifying its status. During initial setup, a pumping speed versus flow curve 336 and/or a pressure versus flow curve 340 is measured 414. The process is then initiated 416.

If at some later time it is desired that the previous process be repeated, the hardware previously used (or hardware identical thereto) is gathered and assembled 418, and a measurement 420 of at least one pumping speed versus flow rate value 338 or pressure versus flow rate value 342, typically from a middle portion of the measured curve 336, 340, is repeated and compared to the value or values obtained during the original process run 422 to ensure that the same or identical equipment is being used, and that the thermal exchange liquid circulation system has not changed or degraded since the process was previously run. In embodiments, the entire pumping speed versus flow curve 306 and/or pressure versus flow curve 302 measurements are repeated and compared. If the measured points agree with the original points to within a certain tolerance 422, then the process run is allowed to proceed 424. If not, then the hardware is inspected, repaired, replaced, cleaned, or otherwise adjusted, and the selected points are re-measured 420. In similar embodiments, the entire pumping speed versus flow curve 336 and/or the complete pressure versus flow rate curve 340 is re-measured and compared with the originally measured curve(s).

In some embodiments, once the initial pumping speed versus flow data set 336 and/or pressure-versus-flow data set 340 has been established 426 and the process has been started 428, values 338, 342 from the data curves 336, 340 are periodically re-measured 432 and compared to the initial data set 302, 306 so as to detect if any hardware degradation, changes, or failures have taken place during the run. If the measured points agree with the initially measured points to within a specified tolerance 434, then the process is allowed to proceed 428. If not, the process is stopped 436 and an operator is alerted. In certain embodiments, if the process run is temporarily paused and then re-started for some reason 430, the re-measurement 432 and comparison 434 can be used to determine if the pause or if any adjustments made during the pause led to any degradation or change in the system.

In embodiments, measurements of flow versus both pumping speed 336 and pressure 340 are made before beginning the process run, and are repeated during the process run, so that variations in pumping speed versus pressure can be used to detect and/or anticipate an eventual requirement to refurbish or replace the circulator.

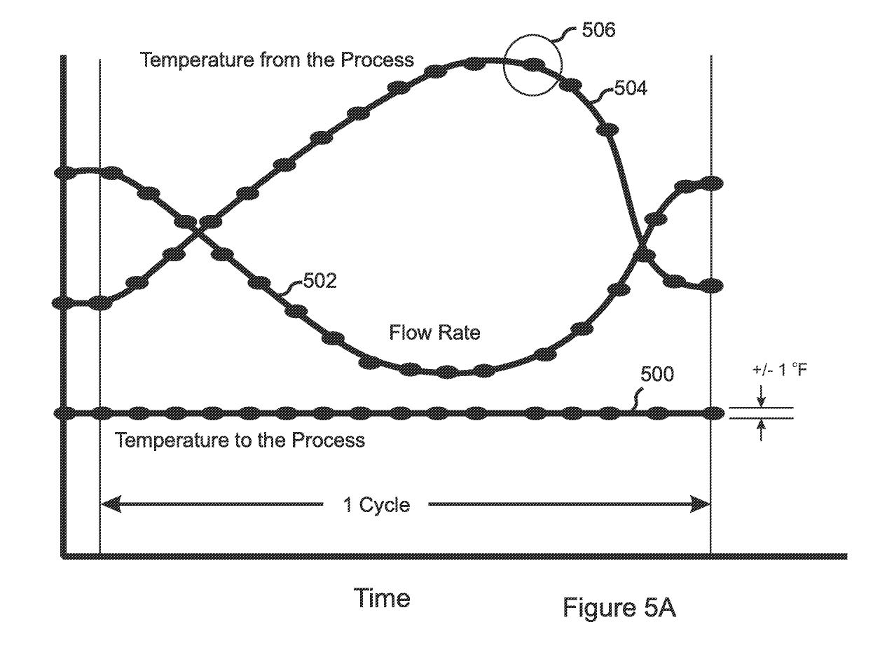

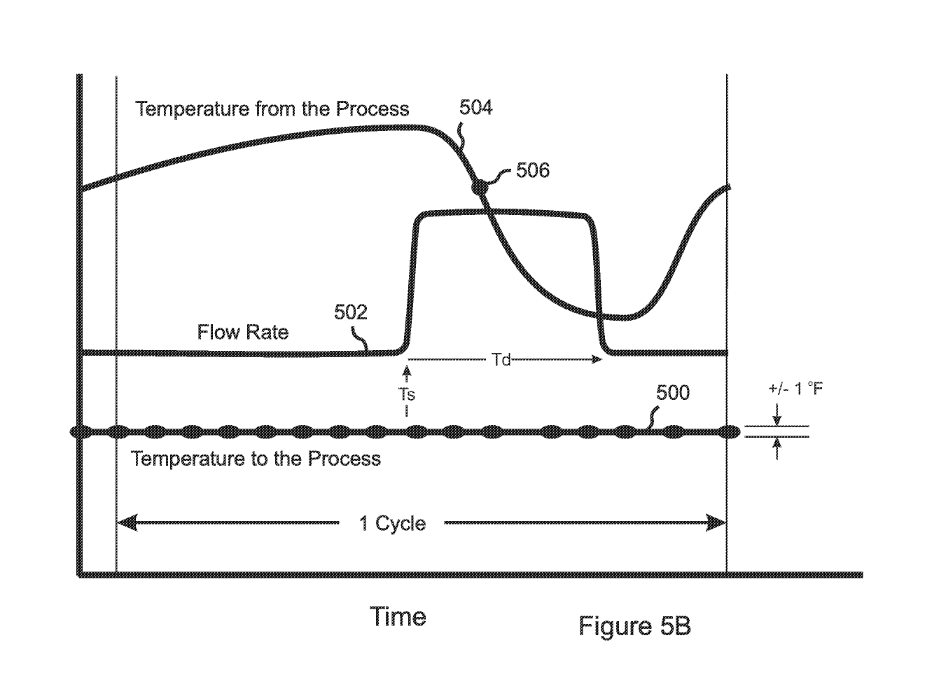

Other general aspects of the present invention include measurement of the flow rate and the temperatures of the thermal exchange liquid to the process 204 and from the process 206. FIG. 5 illustrates a typical set of measured points and associated curves obtained using the apparatus of FIG. 2 during a single process cycle for an embodiment in which the circulator 200 maintains the temperature to the process 500 at a substantially constant value during the cycle (in some embodiments within 0.1° F.), while the flow rate 502 is intentionally varied in a specified manner according to a pre-determined flow rate profile. The temperature from the process 504 varies during the molding cycle according to thermal factors associated with the molding process and the ambient environment, as well as in response to changes in the cooling flow supplied by the circulator 200. At equilibrium, the curve 504 indicating temperature from the process repeats the same pattern of variation during each molding cycle.

With reference to FIG. 5B, in some embodiments the thermal exchange liquid is applied in a “burst” mode where the flow is either on or off, and the user is able to control only the start time Ts and/or the duration Td of the burst during each cycle. In embodiments, the bursts are generated by controlling the operation of a fixed displacement pump, instead of or in addition to controlling a valve. In some embodiments, a graphical representation of the burst pulse location and duration within a cycle is presented to the user, and in some of these embodiments the user can adjust the starting time and duration by using a pointing device to adjust the graphical representation.

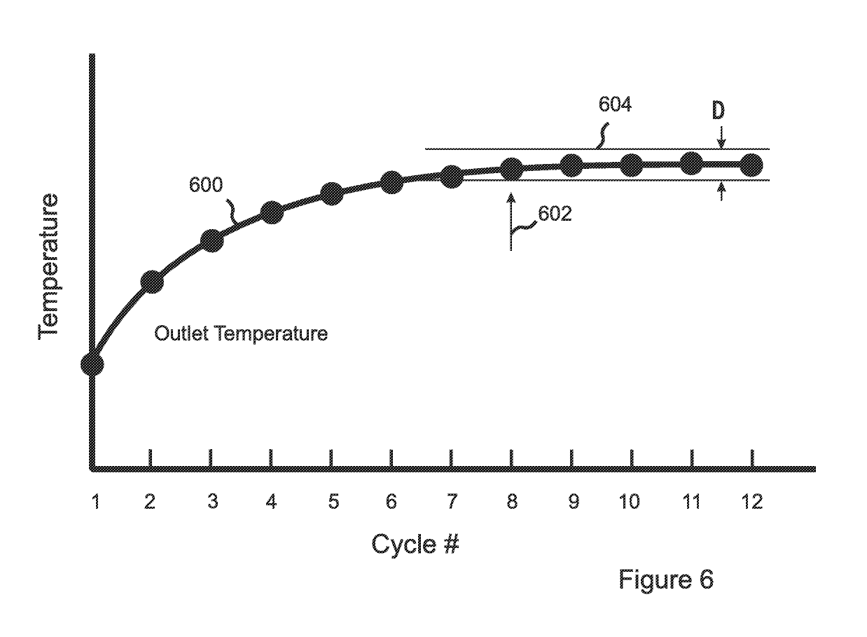

In various embodiments, during initial startup of a molding run, the temperature supplied to the process and the flow rate are held at constant values, and a point 506 on the curve 504 of the temperature from the process is monitored from one molding cycle to the next. As illustrated in FIG. 6, the value of the monitored temperature point 506 varies from one cycle to the next, and the measured values form a start-up curve 600 which approaches an equilibrium value. After a certain number of cycles 602, the measured points will not vary beyond a specified tolerance 604, and the system is deemed to have reached start-up equilibrium, whereby the product can be retained and used. Since the flow rate and temperature to the process are regulated to constant values or to repeated and well defined profiles, monitoring from cycle to cycle of the temperature from the process is equivalent to monitoring the rate of energy exchange between the thermal exchange liquid and the mold, and start-up equilibrium is deemed to have been reached when the energy exchange rate is constant to within a specified tolerance.

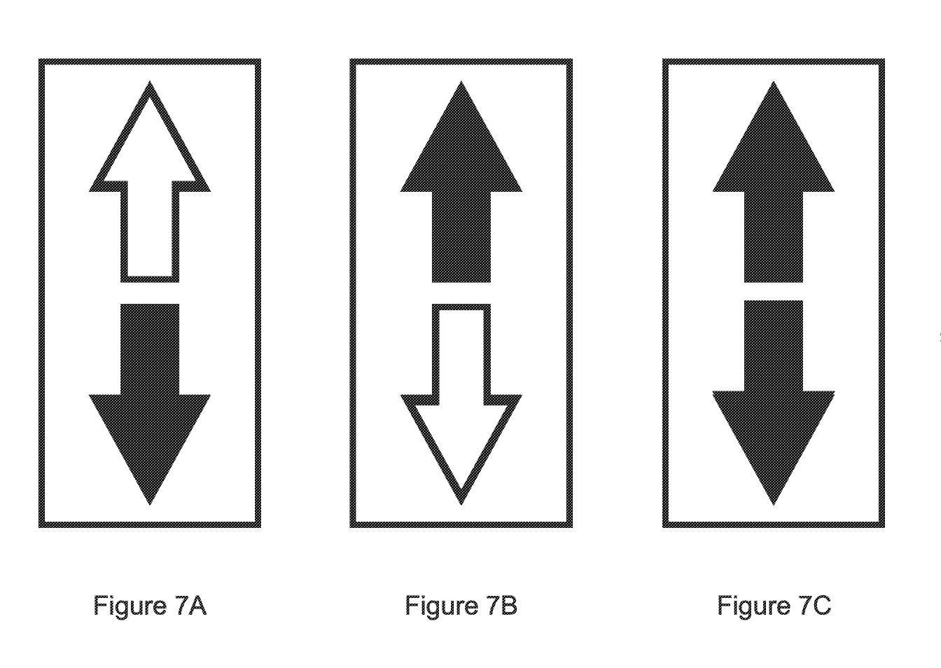

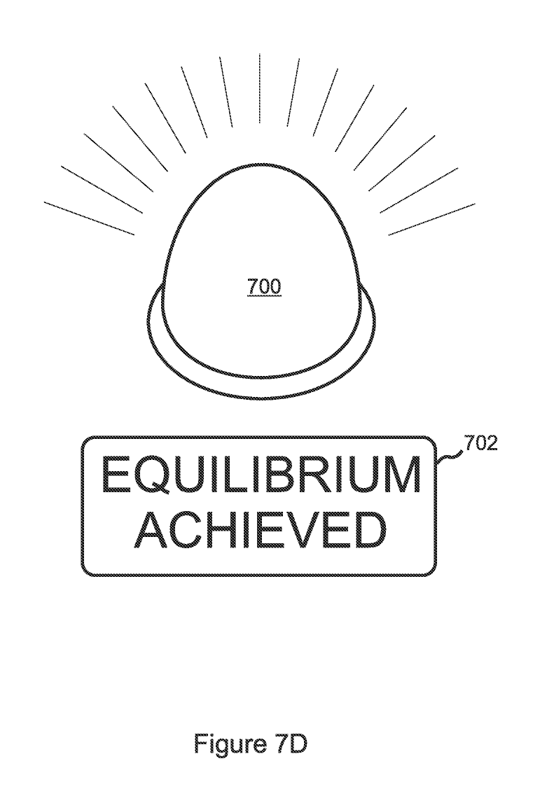

FIG. 7A illustrates a visual indication presented on the circulator control display 112 in some embodiments when the measured temperature or calculated energy exchange rate is below its equilibrium value, FIG. 7B illustrates a visual indication presented on the circulator control display 112 in some embodiments when the measured temperature or calculated energy exchange rate is above its equilibrium value, and FIG. 7C illustrates a visual indication presented on the circulator control display 112 in some embodiments when the measured temperature or calculated energy exchange rate is within the specified tolerance range 604 of its equilibrium value. FIG. 7D illustrates a similar embodiment where a single illuminated indication 700 and text label 702 indicate when equilibrium has been achieved, without providing any indication as to whether the temperature or energy exchange rate is rising or falling as the system approaches equilibrium.

In some embodiments, monitoring of the temperature points 506 from the process and/or the energy exchange rate (on a selected point or cycle average basis) continues during the run, so as to detect any unexpected changes or deviations of the system, for example due to degradation or clogging of a cooling line, a change in the properties of the raw material introduced into the mold, a change in ambient conditions such as the surrounding temperature, and such like. If the points 506 vary beyond the specified tolerance range 604, the process is halted and/or an operator is alerted.

In various embodiments, during set up of a molding run the temperature to the process 500, the temperature from the process 504, and the flow rate 502 are used to calculate the average rate of energy exchange between the thermal exchange liquid and the mold during each cycle. At the same time, the energy consumption 208 of the circulator pump and/or of the complete circulator system is monitored, and compared with the energy exchange rate. The flow rate 502 and/or temperature to the process 500 are then varied above and below initially selected values to determine conditions of maximum cooling efficiency whereby the quantity of energy exchanged with the mold per BTU (or equivalent unit) of circulator energy consumption is a maximum. In many instances, this provides the most energy efficient operating conditions for the circulator.

While there are advantages to repeating a molding run under conditions which are virtually identical to a previous run, this is not always possible. And even if the same circulator conditions can be nominally reproduced, there can still be variations in the process and environment such as changes in ambient temperature, changes in the physical or chemical properties of the raw materials introduced into the mold, and short or long term degradation in the cooling system. For these and other reasons, it can be desirable to monitor and control the actual thermal environment within in the mold during each molding cycle. As has been discussed above, one approach of the prior art is to provide temperature sensors in the mold, and attempt to manually or automatically respond to temperature changes detected by these sensors. However, such measurements are necessarily indirect and significantly delayed as compared to what is actually happening in the mold. They are also necessarily limited to one or to only a few locations within the mold, and may not provide an accurate representation of the thermal state of the overall mold system.

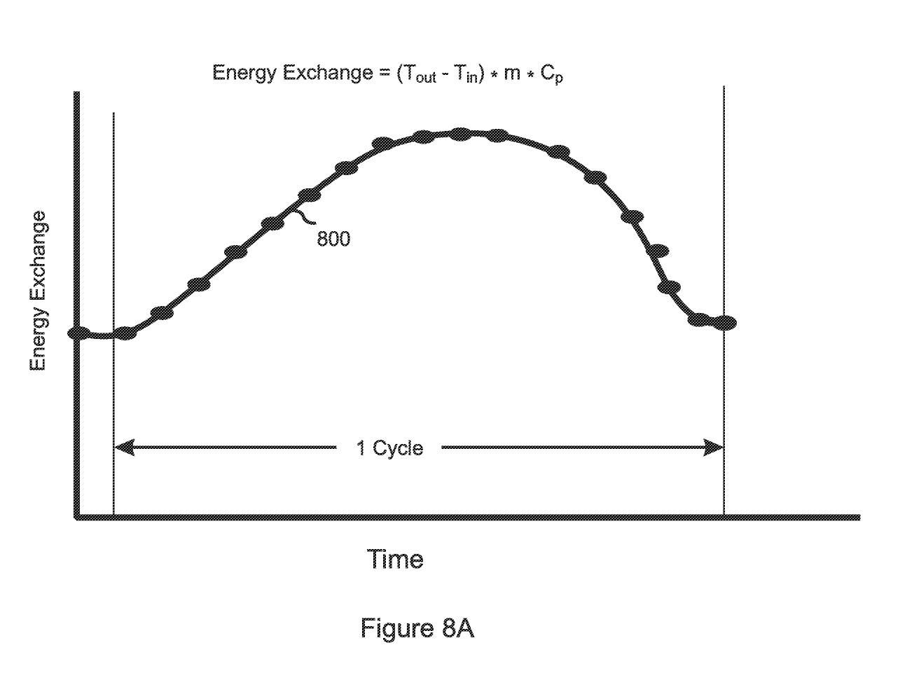

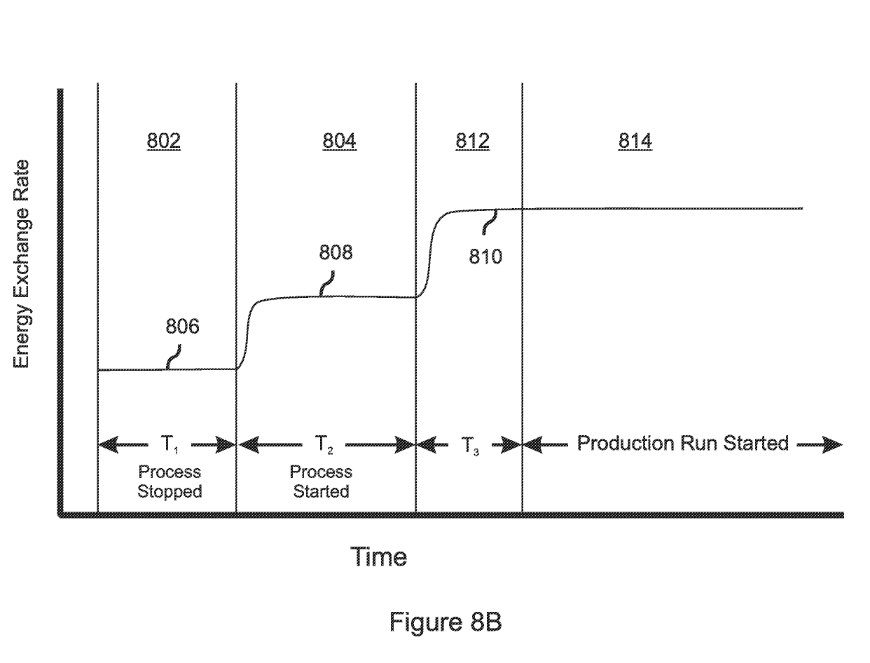

With reference to FIG. 8A, embodiments of the present invention monitor energy exchange with the mold 800 as a direct and responsive method for characterizing and controlling the thermal status of the mold during each mold cycle. In these embodiments, the flow rate and the temperatures of the thermal exchange liquid to and from the process are measured, and the energy exchange ΔE is calculated according to the equation

ΔE=(Tₒᵤₜ−Tᵢₙ)*m*Cₚ (1)

where Tₒᵤₜ is the temperature from the process, Tᵢₙ is the temperature as supplied to the process, m is the mass flow rate of the thermal exchange liquid circulating through the mold, and Cₚ is the specific heat of the thermal exchange liquid. Since liquids are mainly incompressible, m can typically be determined from the flow rate and known properties of the thermal exchange liquid. In some embodiments, the effects of temperature and/or the pressure are also included in the determination of m.

In some embodiments it is desirable to operate a process at a high rate of speed, so as to produce product as rapidly as possible. This necessarily requires that heat be removed from (or added to) the mold at a high rate. The equilibrium temperature of the mold will depend on a balance between the rate at which raw material is added to the mold, and the rate at which heat is exchanged between the thermal exchange liquid and the mold. However, it is usual to begin circulation of the thermal exchange liquid through the mold well before a molding run is started. This means that when the molding run is first started, the mold will typically be at a temperature which is approximately equal to the temperature of the thermal exchange liquid, which may be too cold (or too warm) for the molding process. In extreme cases, the plastic or other raw material may harden too quickly and fail to completely fill the mold, or it may fail to harden by the end of the molding cycle. In either case, the molded material may fail to eject properly, and may cause a failure of the process to start.

In certain embodiments where the temperature of the thermal exchange liquid during a process run is lower than temperature of the process itself, a heater is included in the thermal exchange liquid system, and is used to temporarily warm the thermal exchange liquid to assist in quickly bringing the mold to its calibrated starting temperature, either when a new run is started, or if a molding run is temporarily halted for some reason. In some of these embodiments the heater is a tankless water heater, and the flow rate of the thermal exchange liquid is temporarily reduced during this warm-up process so that the liquid can be heated by the heater to a specified temperature.

With reference to FIG. 8B, in some embodiments of the present invention the rate of energy exchange between the thermal exchange liquid and the mold is monitored and controlled as the circulator is operated, and one or more start-up time intervals 802, 804, are defined during which the energy exchange rate set point 806, 808 is set to relatively lower values than the equilibrium set point 810. In some embodiments, the set point of the temperature to the process is also set to relatively higher or lower values than the equilibrium set point. Then, during a final setup time interval 812 the energy exchange rate set point 810 (and in embodiments also the set point of the temperature to the process) is set to the equilibrium value and the process is allowed to reach thermal equilibrium, after which the actual molding run is begun 814. This method allows the molding run to start properly and then to progress to the desired equilibrium state in an energy controlled manner. In some embodiments, instead of discrete start-up time intervals 802, 804, 812 and set points 806, 808, 810 the energy set point (and in some embodiments also the set point of the temperature to the process) transitions from a starting value 806 to the equilibrium value 810 according to a startup profile.

In various embodiments, the process is brought to equilibrium during the first time interval 802 with the first energy exchange rate set point 806 before operation of the process is started, so as to ensure that the process has reached a known and tested state before operation is attempted. The remainder of the startup procedure 804, 812 then takes place under known and tested conditions. In certain embodiments, this approach applies also to situations wherein a molding run is temporarily halted, for example to remove a part which has failed to properly eject, or to make a minor repair. When the process is ready for re-start, during the first time interval 802 it is brought from whatever untested state it has reached back to equilibrium with the first energy exchange rate set point 806. The remainder of the startup procedure 804, 812 can then be followed under known and tested conditions. In embodiments, the approach to equilibrium with each of the energy set points during the startup procedure is indicated to an operator by visual indications such as those illustrated in FIGS. 7A through 7C. In other embodiments, only the final achievement of equilibrium is indicated, as illustrated in FIG. 7D.

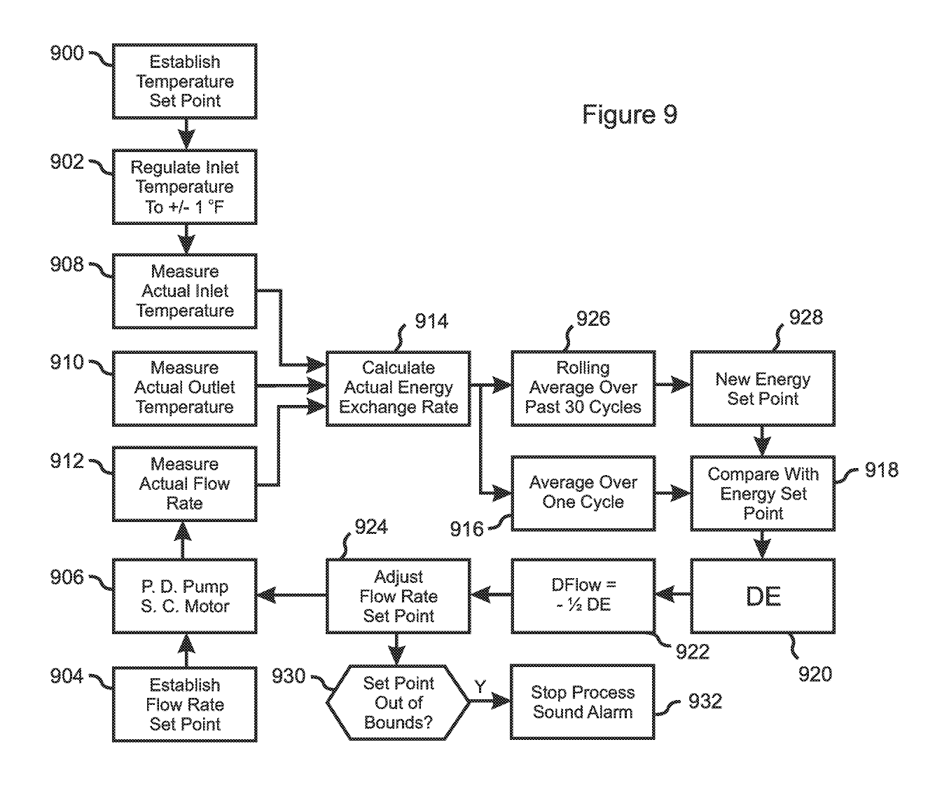

With reference to FIG. 9, in some embodiments the energy exchange rate between the thermal exchange liquid and the process is monitored during each molding cycle and the temperature to the process and/or flow rate or pumping rate of the circulator is controlled so as to ensure that the average energy exchange rate equals a desired set point exchange rate, or that the energy exchange curve faithfully reproduces a desired energy set point energy exchange profile. In some embodiments, a temperature set point is established 900 and the temperature of the thermal exchange liquid supplied to the process is regulated to the set point 902, in some embodiments to within +/−0.1° F. A flow rate set point is also established 904 and the flow rate is controlled to the set point, using a controlled valve and/or a positive displacement pump (P. D. pump) driven by a programmable, speed controlled motor (S. C. motor) 906.

The actual temperatures of the thermal exchange liquid to the process 908 and from the process 910 are measured, as well as the actual flow rate 912, and these measurements are used to calculate the actual rate of energy exchange between the thermal exchange liquid and the process 914. In embodiments, the actual energy exchange rate is averaged over a molding cycle 916 or over some other selected period, and the average is compared to a desired set point energy exchange rate 918, and the difference ΔE is determined 920. Accordingly, the flow rate set point is adjusted 924 so as to regulate the energy exchange rate to the energy set point. In some embodiments, the adjustment is equal to less than ΔE 922 (e.g. 0.5 times ΔE), so that hypothetically if no further fluctuations occurred (and in practice this is unlikely), the average energy exchange rate over the measured cycle and more than one additional cycle (e.g. two additional cycles) would be equal to the set point.

In some embodiments, the energy exchange rate set point is established as a fixed value. In other embodiments, the energy set point is established and updated during the molding run as a rolling average, whereby after each molding cycle (or after each of some other time interval, such as every minute for some extrusion or other continuous processes), an average actual energy exchange rate over that cycle is combined with averages over a plurality of previous cycles or intervals, such as an average over 30 total cycles 926, so as to calculate a “rolling” or “moving” average which is used to update the energy set point 928 every molding cycle or other interval (e.g. every minute for some continuous processes). The energy set point is thereby always equal to an average of the actual energy exchange rate over a most recent fixed number of intervals, such as the most recent 30 molding cycles.

According to this approach, the energy set point may slowly change during a molding run. In some of these embodiments, if the energy set point evolves beyond an established set of boundaries 930, then a specified action is triggered, such as stopping the process, notifying an operator (e.g. by email or text message), and/or triggering an audible and/or visible alarm 932.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A method for establishing initial operating conditions for a molding system, the molding system including an injection mold, die, or barrel (herein referred to as a “process”), a circulator, and a thermal exchange liquid circulated by the circulator through the process, the method comprising:
before beginning a first process run, accepting from a user a desired flow rate of the thermal exchange liquid and a maximum value of an operating pressure of the thermal exchange liquid;
measuring and recording a flow rate value of the thermal exchange liquid for each of a plurality of values of a flow control parameter spanning a range of achievable values of the flow control parameter, said range of achievable values being limited so that no value within said range causes the operating pressure to exceed the maximum value of the operating pressure;
determining from the measured flow rate values if the desired flow rate can be provided by setting the flow control parameter to a value within the range of achievable values;
if the desired flow rate can be provided, setting an operating value of the flow control parameter to a value that provides the desired flow rate;
if the desired flow rate cannot be provided, informing the user and taking at least one further specified action; and
beginning the process run.

2. The method of claim 1, wherein the flow control parameter is an operating speed of the circulator.

3. The method of claim 1, wherein the flow control parameter is a pressure of the thermal control liquid as it enters the process.

4. The method of claim 1, wherein the flow control parameter is a pressure of the thermal control liquid as it exits the process.

5. The method of claim 1, wherein the flow control parameter is a difference between pressures of the thermal control liquid as it enters the process and exits the process.

6. The method of claim 1, wherein the plurality of values of the flow control parameter includes a value that is 98% of a maximum achievable value, a value that is 90% of the maximum achievable value, and values successively reduced from said 90% value in 10% increments.

7. The method of claim 1, further comprising accepting from said user an alarm value of the operating pressure proximal to said maximum value, said alarm value being a value at which, when achieved, an alarm should be issued to said operator alerting said operator that the operating pressure is close to the maximum value.

8. The method of claim 7, wherein the at least one further specified action includes setting the operating pressure to the alarm pressure, and informing the user as to the resulting flow rate.

9. The method of claim 1, wherein the at least one further specified action includes setting the operating value of the flow control parameter to the value within the range of achievable values that provides a flow rate that is as close as possible to the desired flow rate, and informing the user as to the resulting flow rate.

10. The method of claim 1, wherein the at least one further specified action includes informing the user of the range of flow rates that can be achieved and the corresponding values of the flow control parameter from the range of achievable values of the flow control parameter, allowing the user to revise the desired flow rate to an achievable value, and setting the operating value of the flow control parameter to a value that provides the revised desired flow rate.

11. The method of claim 1, wherein the maximum pressure accepted from the user is not allowed to be more than a specified system maximum pressure value.

12. The method of claim 1, further comprising, after beginning the first process run, measuring a verification flow rate value of the thermal exchange liquid for at least one of the plurality of values of the flow control parameter, and verifying that the verification value is within a specified tolerance of the previously measured value.

13. The method of claim 12, further comprising if the verification fails, stopping the first process run and alerting an operator of the process.

14. The method of claim 12, wherein measuring the verification flow rate value includes temporarily pausing the first process run while the flow rate value is measured.

15. The method of claim 12, wherein measurements of flow versus both pressure and pumping speed are made before beginning the first process run and are compared with verification measurements made during the first process run, and variations in pumping speed versus pressure are used to at least one of detect and anticipate an eventual requirement to refurbish or replace the circulator.

16. The method of claim 1, further comprising, after completing the first process run and before beginning a second process run, measuring a verification flow rate value of the thermal exchange liquid for at least one of the plurality of values of the flow control parameter, and verifying that the verification value is within a specified tolerance of the corresponding value measured before beginning the first process run.

17. The method of claim 16, further comprising if the verification fails, at least one of inspecting, repairing, replacing, cleaning, and adjusting at least one element of the molding system.

18. The method of claim 16, further comprising if the verification fails, measuring and recording a new flow rate value of the thermal exchange liquid for each of the plurality of values of the flow control parameter spanning the range of achievable values of the flow control parameter, and establishing new initial operating conditions for the molding system.

19. The method of claim 16, wherein a verification flow rate value is measured for each value of the thermal exchange liquid for which a flow rate value was measured before beginning the first process run, and the verification fails if any of the verification flow rate values is not within the specified tolerance of the corresponding value measured before beginning the first process run.

20. The method of claim 16, wherein measurements of flow versus both pressure and pumping speed are made before beginning the first process run and are compared with verification measurements before beginning the second process run, and variations in pumping speed versus pressure are used to at least one of detect and anticipate an eventual requirement to refurbish or replace the circulator.
